(19) United States
(12) Patent Application Publication
(10) Pub. No.: US 2017/0142182 A1
(43) Pub. Date: May 18, 2017

(54) SYSTEM AND METHOD FOR SHARING MULTIMEDIA CONTENT

(71) Applicant: Cortica, Ltd., TEL AVIV (IL)

(72) Inventors: Igal Raichelgauz, New York, NY (US); Karina Odinaev, New York, NY (US); Yehoshua Y Zeevi, Haifa (IL)

(73) Assignee: Cortica, Ltd., TEL AVIV (IL)

(21) Appl. No.: 15/419,567

(22) Filed: Jan. 30, 2017

Related U.S. Application Data
(63) Continuation of application No. 62/307,519, filed on Mar. 13, 2016.
Application No. 62/307,519 is a continuation-in-part of application No. 13/770,603, filed on Feb. 19, 2013.
Application No. 13/770,603 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.

(30) Foreign Application Priority Data
Oct. 26, 2005 (IL) 171577
Jan. 29, 2006 (IL) 173409
Aug. 21, 2007 (IL) 185414

(51) Int. Cl. H04L 29/06; H04L 29/08; H04L 12/26

(52) U.S. Cl. CPC H04L 65/607; H04L 43/08; H04L 67/10; H04L 67/42

(57) ABSTRACT

A system and method for automated sharing multimedia content. The method includes: detecting at least one sharing trigger event, wherein the at least one sharing trigger event is related to at least one multimedia content element to be shared by a sharing device; determining, for each multimedia content element, correlations among a plurality of signatures generated for the multimedia content element, wherein each signature represents an abstract depiction of at least a portion of the multimedia content element; generating, based on the determined correlations, at least one contextual parameter, each contextual parameter indicating a context of one of the at least one multimedia content element; identifying, based on the generated at least one contextual parameter, at least one recipient device, wherein the identified at least one recipient device does not include the sharing device; and sharing the at least one multimedia content element with the at least one recipient device.

### CROSS-REFERENCE TO RELATED APPLICATIONS

This application claims the benefit of U.S. Provisional Application No. 62/307,519 filed on Mar. 13, 2016. This application is also a continuation-in-part (CIP) of U.S. patent application Ser. No. 13/770,603 filed on Feb. 19, 2016, now pending, which is a CIP of U.S. patent application Ser. No. 13/624,397 filed on Sep. 21, 2012, now U.S. Pat. No. 9,191,626. The Ser. No. 13/624,397 application is a CIP of:

(a) U.S. patent application Ser. No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and

(c) U.S. patent application Ser. No. 12/084,150 having a filing date of Apr. 7, 2009, now U.S. Pat. No. 8,655,801, which is the National Stage of International Application No. PCT/IL2006/001235 filed on Oct. 26, 2006, which claims foreign priority from Israeli Application No. 171577 filed on Oct. 26, 2005, and Israeli Application No. 173409 filed on Jan. 29, 2006.

The contents of the above-referenced applications are hereby incorporated by reference.

### TECHNICAL FIELD

The present disclosure relates generally to sharing multimedia content, and more specifically to sharing multimedia content based on contextual analysis of the multimedia content.

### BACKGROUND

As the Internet continues to grow exponentially in size and content, the task of finding relevant and appropriate information has become increasingly complex. As a result, many users of the Internet share content with other users that they believe would be relevant to those other users.

Upon finding content on the Internet, many users seek to share the content with another person, either instantly or at some point in the future. Existing methods for sharing such content include sending a URL to a web address of the content to other users, uploading the content to a cloud-based storage unit accessible to other users (e.g., by sending a link to the location in the cloud-based storage in which the content is stored), or providing verbal or written instructions on how to find the content (for example, a user may tell another user to search for particular key words using a search engine).

Users seeking to share content often wish to share content including multiple files or to share a subject of interest which may be related to content in multiple files. In such cases, the content from the multiple files may be in different resources. Further, the different resources may have different restrictions on access (e.g., different requirements for access, different entities that are granted access, etc.). Finding, retrieving, and sharing the multiple files may therefore be complex, inconvenient, and potentially impossible.

Moreover, users may also experience difficulty sharing content when the shared content is linked or otherwise provided from a first type of device to a second, different type of device. For example, when content is shared via a link sent from a mobile device to a personal computer, the link may not operate properly upon access by the user of the personal computer. This improper operation may be due to, e.g., the linked content being optimized for mobile devices but not for personal computers, the linked content being accessible via an application designed for the mobile device, and the like.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The embodiments disclosed herein include a method for sharing multimedia content. The method includes: detecting at least one sharing trigger event, wherein the at least one sharing trigger event is related to at least one multimedia content element to be shared by a sharing device; determining, for each multimedia content element, correlations among a plurality of signatures generated for the multimedia content element, wherein each signature represents an abstract depiction of at least a portion of the multimedia content element; generating, based on the determined correlations, at least one contextual parameter, each contextual parameter indicating a context of one of the at least one multimedia content element; identifying, based on the generated at least one contextual parameter, at least one recipient device, wherein the identified at least one recipient device does not include the sharing device; and sharing the at least one multimedia content element with the at least one recipient device.

The embodiments disclosed herein also include a non-transitory computer readable medium having stored thereon instructions for causing one or more processing units to execute a process, the process comprising: detecting at least one sharing trigger event, wherein the at least one sharing trigger event is related to at least one multimedia content element to be shared by a sharing device; determining, for each multimedia content element, correlations among a plurality of signatures generated for the multimedia content element, wherein each signature represents an abstract depiction of at least a portion of the multimedia content element; generating, based on the determined correlations, at least one contextual parameter, each contextual parameter indicating a context of one of the at least one multimedia content element; identifying, based on the generated at least one contextual parameter, at least one recipient device, wherein the identified at least one recipient device does not include the sharing device; and sharing the at least one multimedia content element with the at least one recipient device.

The embodiments disclosed herein also include a system for sharing multimedia content, comprising: a processing circuitry; and a memory, the memory containing instructions that, when executed by the processing circuitry, configure the system to: detect at least one sharing trigger event, wherein the at least one sharing trigger event is related to at least one multimedia content element to be shared by a sharing device; determine, for each multimedia content element, correlations among a plurality of signatures generated for the multimedia content element, wherein each signature represents an abstract depiction of at least a portion of the multimedia content element; generate, based on the determined correlations, at least one contextual parameter, each contextual parameter indicating a context of one of the at least one multimedia content element; identify, based on the generated at least one contextual parameter, at least one recipient device, wherein the identified at least one recipient device does not include the sharing device; and share the at least one multimedia content element with the at least one recipient device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for sharing multimedia content according to an embodiment.

FIG. 3 is a flowchart illustrating a method for generating contextual parameters for multimedia content elements according to an embodiment.

FIG. 4 is a block diagram depicting the basic flow of information in the signature generator system.

FIG. 5 is a diagram showing the flow of patches generation, response vector generation, and signature generation in a large-scale speech-to-text system.

FIG. 6 is a block diagram illustrating a sharing system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for sharing multimedia content. At least one sharing trigger event related is detected. Each sharing trigger event is related to at least one multimedia content element to be shared by a sharing device. The sharing trigger event may include receiving, from the sharing device, the at least one multimedia content element, a request to share the at least one multimedia content element, or both. Signatures are generated or obtained for each multimedia content element. For each multimedia content element, based on the signatures for the multimedia content element, at least one contextual parameter indicating a context of the multimedia content element is generated. At least one recipient device with which content is to be shared is determined based on the generated at least one contextual parameter. The at least one multimedia content element is shared with the determined at least one recipient device. The sharing may include, but is not limited to, peer-to-peer sharing the at least one multimedia content.

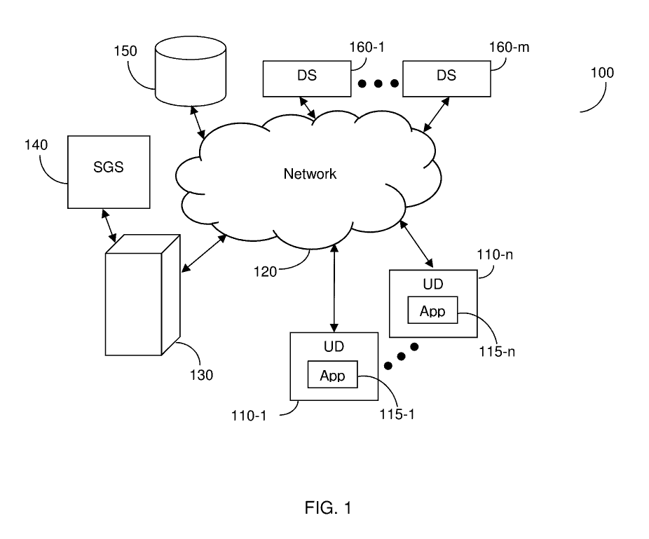

FIG. 1 shows an example network diagram 100 utilized to describe the various embodiments disclosed herein. The example network diagram includes a plurality of user devices (UDs) 110-1 through 110-n (hereinafter referred to individually as a user device 110 and collectively as user devices 110, merely for simplicity purposes), a sharing system 130, a database 150, and a plurality of data sources 160-1 through 160-m (hereinafter referred to individually as a data source 160 and collectively as data sources 160, merely for simplicity purposes), communicatively connected via a network 120.

The network 120 is used to communicate between different components of the network diagram 100. The network 120 may be the Internet, the world-wide-web (WWW), a local area network (LAN), a wide area network (WAN), a metro area network (MAN), and other networks capable of enabling communication between the components of the network diagram 100.

Each user device 110 may be, but is not limited to, a personal computer (PC), a personal digital assistant (PDA), a mobile phone, a smart phone, a tablet computer, a wearable computing device, a smart television, and other devices configured for storing, viewing, and sending multimedia content elements.

Each user device 110 may have installed thereon an application (app) 115. The applications 115 may be downloaded from applications repositories such as, but not limited to, the AppStore®, Google Play®, or any other repositories storing applications. Each application 115 may be pre-installed in the respective user device 110. The application 115 may be, but is not limited to, a mobile application, a virtual application, a web application, a native application, and the like. In an example implementation, the application 115 is a web browser.

Each of the data sources 160 may be, for example, a web server, an application server, a publisher server, a data repository, a database, and the like. Specifically, the data sources 160 may include content such as, but not limited to, social networking information, blogs, news feeds, photo albums, multimedia content elements, and the like.

In an embodiment, the sharing system 130 is configured to share content and, specifically, multimedia content elements, between users of the user devices 110. To this end, the sharing system 130 is configured to trigger the sharing of the multimedia content elements in response to at least one sharing trigger event. The at least one sharing trigger event is related to at least one multimedia content element to be shared by a sharing device and may include, but is not limited to, receiving at least one multimedia content element, receiving a request to share at least one multimedia content element, or both.

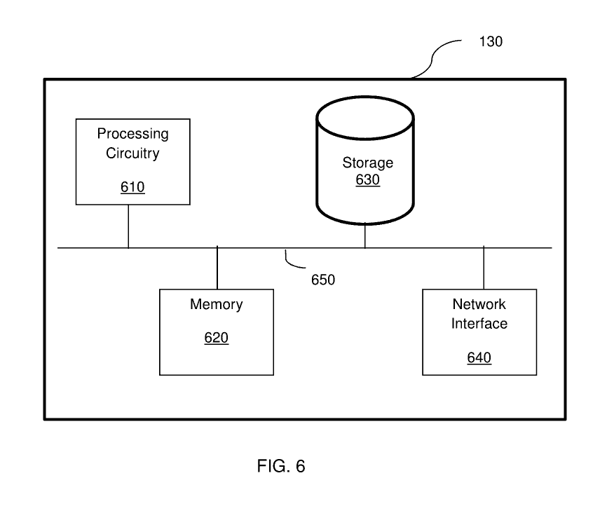

The sharing system 130 typically includes, but is not limited to, a processing circuitry connected to a memory, the memory containing instructions that, when executed by the processing circuitry, configure the sharing system 130 to at least perform sharing of multimedia content elements as described herein. An example block diagram of the sharing system 130 is described further herein below with respect to FIG. 6.

In an embodiment, the sharing system 130 is configured to receive, from a sharing device (e.g., the user device 110-1), at least one multimedia content element to be shared or a request to share multimedia content. The request may include, but is not limited to, the at least one multimedia content element to be shared, an identifier of the at least one multimedia content element to be shared, an indicator of a location of the at least one multimedia content element to be shared, a combination thereof, and the like. As non-limiting examples, the request may include an image to be shared, an identifier used for finding the image, a location of the image in a storage (e.g., one of the data sources 160), or a combination thereof.

The content to be shared may include, but is not limited to, multimedia content elements. The multimedia content elements may include, but are not limited to, images, graphics, video streams, video clips, audio streams, audio clips, video frames, photographs, images of signals (e.g., spectrograms, phasograms, scalograms, etc.), combinations thereof, portions thereof, and the like.

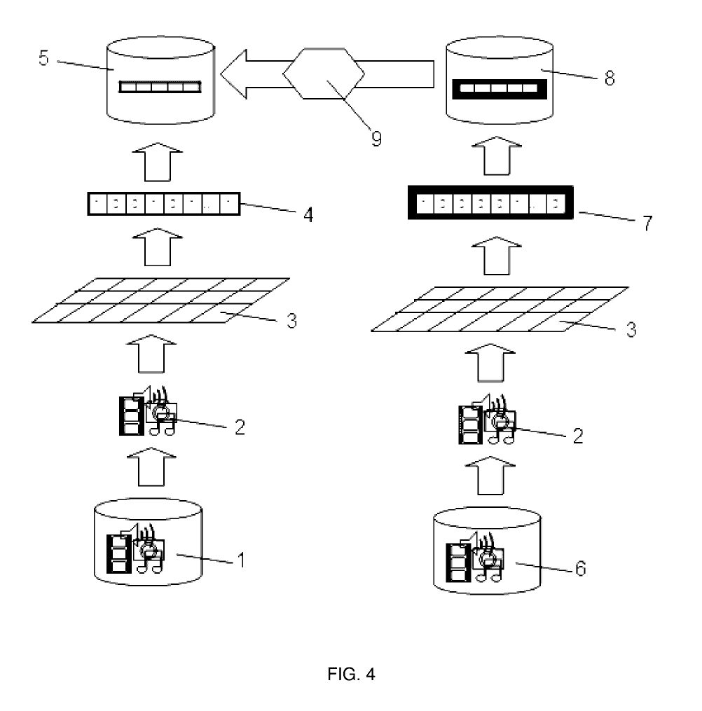

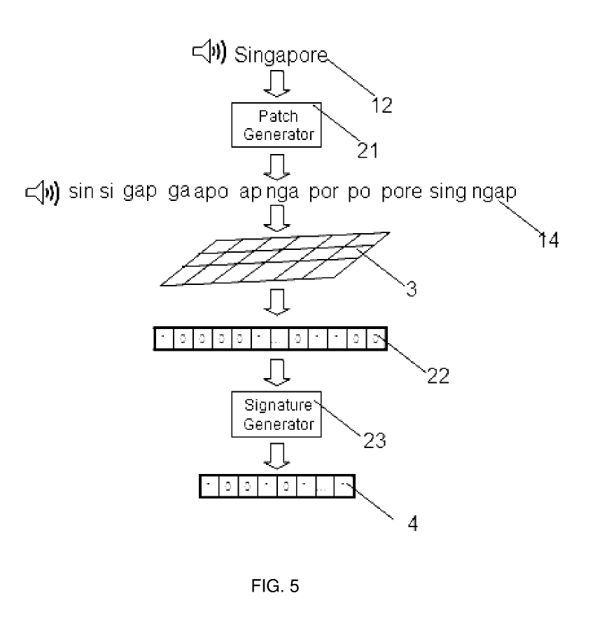

In an optional embodiment, the sharing system 130 is further communicatively connected to a signature generator system (SGS) 140. In a further embodiment, the sharing system 130 may be configured to send, to the signature generator system 140, one or more multimedia content elements. The signature generator system 140 is configured to generate signatures based on the multimedia content elements and to send the generated signatures to the sharing system 130. In another embodiment, the sharing system 130 may be configured to generate the signatures. Generation of signatures based on multimedia content elements is described further herein below with respect to FIGS. 4 and 5.

It should be noted that using signatures for determining the context ensures more accurate reorganization of multimedia content than, for example, when using metadata. For instance, in order to provide a suitable recipient device for an image of a sports car, it may be desirable to determine a particular model of the car. However, in most cases the model of the car would not be part of the metadata associated with the multimedia content (image). Moreover, the car shown in an image may be at angles different from the angles of a specific photograph of the car that is available as a search item. The signature generated for that image would enable accurate recognition of the model of the car because the signatures generated for the multimedia content elements, according to the disclosed embodiments, allow for recognition and classification of multimedia content elements, such as, content-tracking, video filtering, multimedia taxonomy generation, video fingerprinting, speech-to-text, audio classification, element recognition, video/image search and any other application requiring content-based signatures generation and matching for large content volumes such as, web and other large-scale databases.

In an embodiment, for each multimedia content element, the sharing system 130 is configured to generate, based on the signatures for each multimedia content element, at least one contextual parameter indicating a context of the multimedia content element. In a further embodiment, the sharing system 130 is configured to determine correlations among the signatures for each multimedia content element, where the at least one contextual parameter of the multimedia content element is generated based on the determined correlations. Each contextual parameter may be, but is not limited to, a textual or other representation of a context of one of the multimedia content elements.

In an embodiment, the sharing system 130 is further configured to identify, based on the at least one contextual parameter, at least one recipient device (e.g., the user devices 110-2 through 110-N). Each of the user devices 110 may be associated with one or more contextual parameters such that, based on the at least one contextual parameter, at least one recipient device that is associated with the at least one contextual parameter may be identified. The associations may be determined based on, e.g., a user profile of the sharing device attempting to share the content (e.g., a user of the user device 110-1). As a non-limiting example, when the context of the multimedia content elements is indicated by the contextual parameter “sports,” the user devices 110-4 and 110-6 may be identified as recipient devices due to associations between “sports” contextual parameters and the user devices 110-4 and 110-6 in a user profile of the user device 110-1. The users of the user devices 110-4 and 110-6 may be, for example, teammates of a soccer team that the user of the user device 110-1 belongs to.

In an embodiment, the sharing system 130 is configured to share the at least one multimedia content element with the identified at least one recipient device. The sharing may be via the network 120. The sharing may include, but is not limited to, generating a folder including one or more pointers (e.g., links such as URLs) to addresses of the shared multimedia content elements (e.g., a link to a location in the database 150 in which the multimedia contents are stored), sending the shared multimedia content elements to the at least one recipient device, storing the shared multimedia content elements in a storage (e.g., the database 150) accessible to the at least one recipient device, and the like. Sending the multimedia content elements to the at least one recipient device may further include retrieving (e.g., from one or more of the data sources 160, from the database 150, or both) the multimedia content elements to be sent.

In a further embodiment, the sharing system 130 may be further configured to continuously, periodically, or otherwise subsequently check whether the pointers to the shared multimedia content elements are still valid (i.e., that each pointer still accurately references an address of the corresponding shared multimedia content element) and, if not, to update the pointers.

In another embodiment, sharing the at least one multimedia content element with the identified at least one recipient device may include sharing different multimedia content elements with different subsets of the at least one recipient device. Sharing different multimedia content elements with different recipient devices may be useful when, for example, the different multimedia content elements are unrelated (i.e., when the different multimedia content elements do not share any contextual parameters). As a non-limiting example, an audio clip of Jazz music may be shared with the user devices 110-1 and 110-2, a video of standup comedy may be shared with the user devices 110-3 and 110-4, and an image of classic cars may be shared with the user devices 110-2, 110-5, and 110-6. As noted above, the recipient devices for each multimedia content element to be shared may be identified based on the contextual parameters for the multimedia content element.

The database 150 stores multimedia content elements, clusters of multimedia content elements, contextual parameters associated with multimedia content elements, or combinations thereof. In the example network diagram 100 shown in FIG. 1, the sharing system 130 communicates with the database 150 through the network 120. In other non-limiting configurations, the sharing system 130 may be directly connected to the database 150.

It should also be noted that the signature generator system 140 is shown in FIG. 1 as being directly connected to the sharing system 130 merely for simplicity purposes and without limitation on the disclosed embodiments. The signature generator system 140 may be included in the sharing system 130 or communicatively connected to the sharing system 130 over, e.g., the network 120, without departing from the scope of the disclosure.

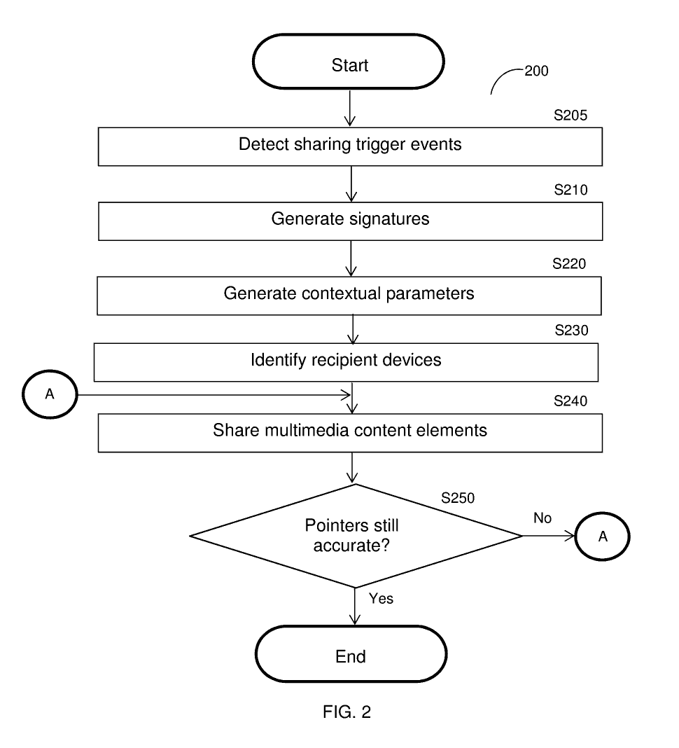

FIG. 2 is an example flowchart 200 illustrating a method for sharing multimedia content according to an embodiment. In an embodiment, the method may be performed by a sharing system (e.g., the sharing system 130, FIG. 1).

At S205, at least one sharing trigger event is detected. The at least one sharing trigger event is related to at least one multimedia content element to be shared by a sharing device and may include, but is not limited to, receiving the at least one multimedia content element, receiving a request to share the at least one multimedia content element, or both. The request may include the multimedia content to be shared, an identifier of the multimedia content, an indicator of a location of the multimedia content, or a combination thereof.

At optional S210, a plurality of signatures is generated for each multimedia content element to be shared. Each signature represents a concept of at least a portion of the multimedia content element. Each generated signature may be robust to noise and distortion. The signatures may be generated via a plurality of at least partially statistically independent computational cores, where the properties of each computational core are set independently of those of each other core, as described further herein below with respect to FIGS. 4 and 5.

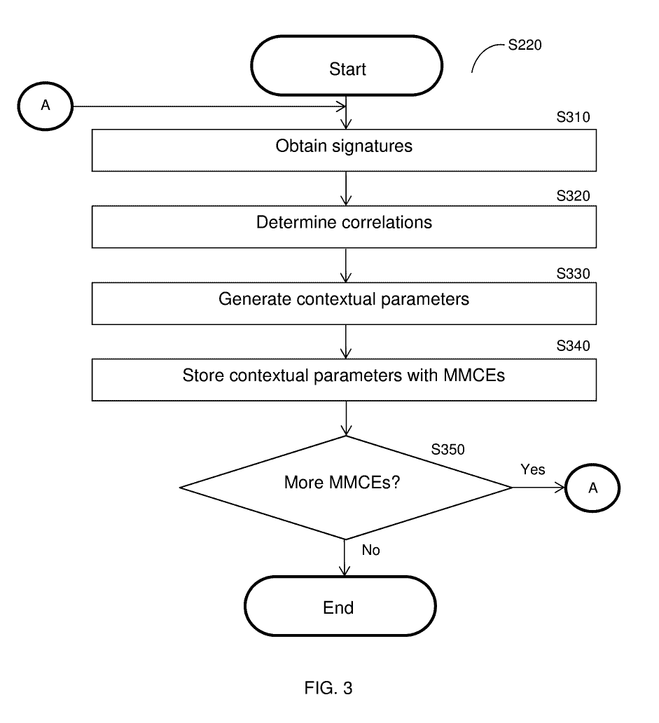

At S220, at least one contextual parameter is generated for each multimedia content element based on a plurality of signatures generated for the multimedia content element. The signatures may include the signatures generated at S210, signatures obtained from, e.g., a database or a signature generator system, and the like. In an embodiment, S220 includes correlating among a plurality of signatures of each multimedia content element to determine at least one correlation among concepts of the multimedia content element, where each contextual parameter is generated based on at least a portion of the determined correlations. Each contextual parameter indicates a context of a multimedia content element. Generating contextual parameters is described further herein below with respect to FIG. 3.

At S230, based on the at least one contextual parameter, at least one recipient device is identified. Each recipient device may be, but is not limited to, a user device (e.g., one of the user devices 110, FIG. 1). The at least one identified user device typically does not include the sharing device. In an embodiment, S230 includes matching the generated at least one contextual parameter to at least one predetermined contextual parameter of a user profile (e.g., a user profiled associated with the sharing device). In a further embodiment, each predetermined contextual parameter of the user profile is associated with at least one user device such that the identified at least one recipient device includes each user device associated with a predetermined contextual parameter that matches one of the at least one generated contextual parameter. The matching may be, e.g., based on a predetermined threshold.

In an embodiment, different recipient devices may be identified with respect to different multimedia content elements (e.g., when the contextual parameters of the multimedia content elements differ). For example, a first recipient device may be identified for a first multimedia content element, and a second recipient device may be identified for a second multimedia content element having different contextual parameters. In a further embodiment, each multimedia content element is only shared with recipient devices identified with respect to the multimedia content element.

As a non-limiting example for identifying recipient devices for a multimedia content element, the generated at least one contextual parameter for an image of a user includes the contextual parameters “rock climbing” and “vacation.” A user profile of the user associates the contextual parameter “rock climbing” with user devices of friends of the user belonging to a rock climbing club and associates the contextual parameter “vacation” with user devices of close friends and family of the user. The generated contextual parameters are matched to the contextual parameters of the user profile, and the user devices associated with each matching contextual parameter “rock climbing” and “vacation” are identified as recipient devices.

At S240, the at least one multimedia content element is shared with the identified at least one recipient device. In an embodiment, S240 may include, but is not limited to, generating at least one folder including one or more pointers to an address of one or more of the shared multimedia content elements, sending the shared multimedia content elements to the at least one recipient device, storing the shared multimedia content elements in a storage accessible to the at least one recipient device, or a combination thereof. In a further embodiment, S240 may also include generating a notification indicating the sharing of the shared multimedia content elements and sending, to each recipient device, the notification. The notification may further include the shared multimedia content elements or pointers thereto.

In another embodiment, S240 may include sharing different multimedia content elements with different subsets of the at least one recipient device. For example, for at least one multimedia content element including a picture of a dog and a video of a cat, the picture of the dog may be shared with a first subset of the at least one recipient device and the video of the cat may be shared with a second subset of the at least one recipient device. The different subsets may at least partially overlap. In a further embodiment, the subset of the at least one recipient device with which each multimedia content element is shared includes the recipient devices identified with respect to the multimedia content element.

At optional S250, when S240 includes generating at least one folder including one or more pointers to the shared multimedia content elements, it may be checked whether the pointers to the shared multimedia content elements are valid and, if so, execution terminates; otherwise, execution continues with S240. In an embodiment, S250 may include checking the accuracy of the pointers once, continuously, periodically, or otherwise subsequent to sharing. In a further embodiment, S250 includes checking multiple times. The pointers may be valid if, e.g., the pointers reference the respective shared multimedia content elements. To this end, S250 may include activating the pointers and determining, based on the activation, whether the shared multimedia content elements are referenced.

FIG. 3 is an example flowchart S220 illustrating a method for determining a context of a multimedia content element according to an embodiment.

At optional S310, a plurality of signatures is obtained for the multimedia content element. In an embodiment, the plurality of signatures includes a signature for a plurality of portions of the multimedia content element. For example, for an image multimedia content element including portions such as a child and a Ferris wheel, the signatures may include signatures for each of the child and the Ferris wheel.

In an embodiment, S310 may include receiving, from a signature generator system (e.g., the signature generator system 140, FIG. 1), the signatures for the multimedia content element. In a further embodiment, S310 may further include sending, to the signature generator system, the multimedia content element, where the signature generator system generates the plurality of signatures based on the sent multimedia content element. The signature generator system may include, but is not limited to, a plurality of at least partially statistically independent computational cores, the properties of each core being set independently of the properties of each other core, as described further herein below with respect to S320.

In another embodiment, previously generated signatures (e.g., signatures generated at S210, FIG. 2) may be utilized.

At S320, correlations among the obtained signatures are determined. Specifically, each signature represents a different concept. The signatures are analyzed to determine the correlations among concepts. A concept is an abstract description of the content to which the signature was generated. For example, a concept of the signature generated for a picture showing a bouquet of red roses is “flowers”. The correlation between concepts can be achieved by identifying a ratio between signatures' sizes, a spatial location of each signature, and so on using probabilistic models. As noted above, a signature represents a concept and is generated for a multimedia content element or portion thereof. Thus, identifying, for example, the ratio of signatures' sizes may also indicate the ratio between the size of their respective multimedia elements.

A context is determined as the correlation between a plurality of concepts. A strong context is determined when there are more concepts, or the plurality of concepts, satisfy the same predefined condition. As an example, signatures generated for multimedia content elements of a smiling child with a Ferris wheel in the background are analyzed. The concept of the signature of the smiling child is “amusement” and the concept of a signature of the Ferris wheel is “amusement park”. The relation between the signatures of the child and recognized wheel is analyzed to determine that the Ferris wheel is bigger than the child. The relation analysis therefore results in determining that the Ferris wheel is used to entertain the child. Thus, the determined context may be “amusement.”

According to an embodiment, one or more typically probabilistic models may be used to determine the correlation between signatures representing concepts. The probabilistic models determine, for example, the probability that a signature may appear in the same orientation and in the same ratio as another signature. When performing the analysis, information stored in one or more databases (e.g., the database 150) may be utilized such as, for example, previously analyzed signatures.

At S330, based on the correlations among the signatures, at least one contextual parameter indicating the context of the multimedia content element is generated. Each contextual parameter may be, but is not limited to, a textual or other representation of the context of the multimedia content element. As a non-limiting example, if signatures generated for a multimedia content element represent people, a soccer ball, and two goals, respectively, the at least one contextual parameter may include the contextual parameter “soccer game.”

In an embodiment, the at least one contextual parameter may be generated further based on features of the multimedia content element such as, but not limited to, relative size, special orientation, and the like. As a non-limiting example, for a multimedia content element showing a child and a Ferris wheel that is smaller than the child, the at least one contextual parameter may include “playing with toys.” As another non-limiting example, for a multimedia content element showing a child and a Ferris wheel that is larger than the child, the at least one contextual parameter may include “at the amusement park.”

As a non-limiting example, an image that contains a plurality of image portions is obtained. Signatures for the plurality of image portions are obtained by sending, to a signature generator system, the plurality of multimedia content elements and receiving, from the signature generator system, signatures generated based on the plurality of multimedia content elements. According to this example, image portions featuring the singer “Adele”, “red carpet” and a “Grammy” award, respectively, are shown in the image. The correlations among “Adele”, “red carpet” and a “Grammy” award are analyzed to determine the context of the image based on the correlation. According to this example such a context may be indicated by a contextual parameter “Adele Winning the Grammy Award”.

The following is another non-limiting example demonstrating generation of contextual parameters. In this example, an image includes a plurality of portions showing objects. According to this example, signatures for objects such as, a “glass”, a “cutlery” and a “plate” which appear in the image are generated. The correlations among the concepts represented by the generated signatures may be analyzed based on data maintained in a database such as, for example, analyses of previously generated signatures. According to this example, as all of the concepts of the “glass”, the “cutlery”, and the “plate” satisfy the same predefined condition, a strong context is determined. The context of such concepts may be indicated by a contextual parameter “table set”. The at least one contextual parameter can be also determined with respect to a ratio of the sizes of the objects (glass, cutlery, and plate) in the image and the distinction of their spatial orientation.

At optional S340, the at least one contextual parameter may be stored with the multimedia content element for future use.

At S350, it is determined if contextual parameters for additional multimedia content elements are to be determined and, if so, execution continues with S310; otherwise, execution terminates.

FIGS. 4 and 5 illustrate the generation of signatures for the multimedia content elements by the signature generator system 140 according to an embodiment. An example high-level description of the process for large scale matching is depicted in FIG. 4. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 5. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the context server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={ni} (1≦i≦L) may consist of a single leaky integrate-to-threshold unit (LTU) node or more nodes. The node ni equations are:

$${V}_{i} = {\sum }_{j} {w}_{ij} {k}_{j}$$

$${n}_{i} = θ ( Vi - {Th}_{x} )$$

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thx is a constant Threshold value, where ‘x’ is ‘S’ for Signature and ‘RS’ for Robust Signature; and Vi is a Coupling Node Value.

The Threshold values Th_{X} are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:

For: Vᵢ>Th_{RS}1−p(V>Th_{S})−1−(1−ε)^{l}<<1 1:
i.e., given that l nodes (cores) constitute a Robust Signature of a certain image I, the probability that not all of these I nodes will belong to the Signature of same, but noisy image, Ĩ is sufficiently low (according to a system's specified accuracy).

p(Vᵢ>Th_{RS})≈l/L 2:
i.e., approximately l out of the total L nodes can be found to generate a Robust Signature according to the above definition.
   3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in the above-referenced U.S. Pat. No. 8,655,801.

FIG. 6 is an example block diagram illustrating a sharing system 130 implemented according to one embodiment. The sharing system 130 includes a processing circuitry 610 coupled to a memory 620, a storage 630, and a network interface 640. In an embodiment, the components of the sharing system 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 610 may be realized as an array of at least partially statistically independent computational cores. The properties of each computational core are set independently of those of each other core, as described further herein above.

The memory 620 may be volatile (e.g., RAM, etc.), non-volatile (e.g., ROM, flash memory, etc.), or a combination thereof. In one configuration, computer readable instructions to implement one or more embodiments disclosed herein may be stored in the storage 630.

In another embodiment, the memory 620 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 610 to perform the various processes described herein. Specifically, the instructions, when executed, cause the processing circuitry 610 to perform sharing multimedia content as described herein.

The storage 630 may be magnetic storage, optical storage, and the like, and may be realized, for example, as flash memory or other memory technology, CD-ROM, Digital Versatile Disks (DVDs), or any other medium which can be used to store the desired information.

The network interface 640 allows the sharing system 130 to communicate with the signature generator system 140 for the purpose of, for example, sending MMCEs, receiving signatures, and the like. Additionally, the network interface 640 allows the sharing system 130 to communicate with the user device 110 in order to obtain MMCEs to be shared.

It should be understood that the embodiments described herein are not limited to the specific architecture illustrated in FIG. 6, and other architectures may be equally used without departing from the scope of the disclosed embodiments. In particular, the sharing system 130 may further include a signature generator system configured to generate signatures as described herein without departing from the scope of the disclosed embodiments.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a step in a method is described as including “at least one of A, B, and C,” the step can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for sharing multimedia content, comprising:
detecting at least one sharing trigger event, wherein the at least one sharing trigger event is related to at least one multimedia content element to be shared by a sharing device;
determining, for each multimedia content element, correlations among a plurality of signatures generated for the multimedia content element, wherein each signature represents an abstract depiction of at least a portion of the multimedia content element;
generating, based on the determined correlations, at least one contextual parameter, each contextual parameter indicating a context of one of the at least one multimedia content element;
identifying, based on the generated at least one contextual parameter, at least one recipient device, wherein the identified at least one recipient device does not include the sharing device; and
sharing the at least one multimedia content element with the at least one recipient device.

2. The method of claim 1, wherein identifying the at least one recipient device further comprises:
matching the generated at least one contextual parameter to at least one predetermined contextual parameter, wherein each predetermined contextual parameter is associated with at least one user device, wherein the at least one recipient device is identified based on the matching.

3. The method of claim 1, further comprising:
obtaining, from a signature generator system, the plurality of signatures generated for each multimedia content element.

4. The method of claim 3, wherein the signature generator system includes a plurality of at least partially statistically independent computational cores, wherein the properties of each computational core are set independently of properties of each other computational core.

5. The method of claim 1, further comprising:
generating, via a plurality of at least partially statistically independent computational cores, the plurality of signatures for each multimedia content element, wherein the properties of each computational core are set independently of the properties of each other computational core.

6. The method of claim 1, wherein the correlations are determined using at least one probabilistic model.

7. The method of claim 1, wherein each signature is robust to noise and distortion.

8. The method of claim 1, wherein sharing the at least one multimedia content element includes at least one of: generating a folder including at least one pointer of the at least one multimedia content element, sending the at least one multimedia content element to the identified at least one recipient device, and storing the at least one multimedia content element in a storage accessible to the identified at least one recipient device.

9. The method of claim 8, further comprising:
checking if the at least one pointer is valid; and
updating the at least one pointer, when it is determined that the at least one pointer is not valid.

10. A non-transitory computer readable medium having stored thereon instructions for causing one or more processing units to execute a method, the method comprising:
detecting at least one sharing trigger event, wherein the at least one sharing trigger event is related to at least one multimedia content element to be shared by a sharing device;
determining, for each multimedia content element, correlations among a plurality of signatures generated for the multimedia content element, wherein each signature represents an abstract depiction of at least a portion of the multimedia content element;
generating, based on the determined correlations, at least one contextual parameter, each contextual parameter indicating a context of one of the at least one multimedia content element;
identifying, based on the generated at least one contextual parameter, at least one recipient device, wherein the identified at least one recipient device does not include the sharing device; and
sharing the at least one multimedia content element with the at least one recipient device.

11. A system for automated sharing multimedia content, comprising:
a processing circuitry; and
a memory, the memory containing instructions that, when executed by the processing circuitry, configure the system to:
detect at least one sharing trigger event, wherein the at least one sharing trigger event is related to at least one multimedia content element to be shared by a sharing device;
determine, for each multimedia content element, correlations among a plurality of signatures generated for the multimedia content element, wherein each signature represents an abstract depiction of at least a portion of the multimedia content element;
generate, based on the determined correlations, at least one contextual parameter, each contextual parameter indicating a context of one of the at least one multimedia content element;
identify, based on the generated at least one contextual parameter, at least one recipient device, wherein the identified at least one recipient device does not include the sharing device; and
share the at least one multimedia content element with the at least one recipient device.

12. The system of claim 11, wherein the system is further configured to:
match the generated at least one contextual parameter to at least one predetermined contextual parameter, wherein each predetermined contextual parameter is associated with at least one user device, wherein the at least one recipient device is identified based on the matching.

13. The system of claim 11, wherein the system is further configured to:
obtain, from a signature generator system, the plurality of signatures generated for each multimedia content element.

14. The system of claim 13, wherein the signature generator system includes a plurality of at least partially statistically independent computational cores, wherein the properties of each computational core are set independently of properties of each other computational core.

15. The system of claim 11, further comprising:
a signature generator system including plurality of at least partially statistically independent computational cores, wherein the properties of each computational core are set independently of properties of each other computational core;
wherein the system is further configured to:
generate, via a plurality of at least partially statistically independent computational cores, the plurality of signatures for each multimedia content element, wherein the properties of each computational core are set independently of the properties of each other computational core.

16. The system of claim 11, wherein the correlations are determined using at least one probabilistic model.

17. The system of claim 11, wherein each signature is robust to noise and distortion.

18. The system of claim 11, wherein the system is further configured to perform at least one of: generate a folder including at least one pointer of the at least one multimedia content element, send the at least one multimedia content element to the identified at least one recipient device, and store the at least one multimedia content element in a storage accessible to the identified at least one recipient device.

19. The system of claim 18, wherein the system is further configured to:
check if the at least one pointer is valid; and
update the at least one pointer, when it is determined that the at least one pointer is not valid.
